(19) United States
(12) Patent Application Publication
(10) Pub. No.: US 2025/0079092 A1
(43) Pub. Date: Mar. 6, 2025

(54) SOLID ELECTROLYTIC CAPACITOR

(71) Applicant: Panasonic Intellectual Property Management Co., Ltd., Kadoma-shi, Osaka (JP)

(72) Inventors: Masahiro Sato, KYOTO FU (JP); Hitoshi Fukui, SAGA KEN (JP)

(73) Assignee: Panasonic Intellectual Property Management Co., Ltd., Kadoma-shi, Osaka (JP)

(21) Appl. No.: 18/724,467

(22) PCT Filed: Oct. 24, 2022
(86) PCT No.: PCT/JP2022/039572

§ 371 Date: Jun. 26, 2024

(30) Foreign Application Priority Data
Dec. 27, 2021 (JP) 2021-212553

(51) Int. Cl. H01G 9/10; H01G 9/012; H01G 9/028; H01G 9/15

(52) U.S. Cl. CPC H01G 9/10; H01G 9/012; H01G 9/028; H01G 9/15

(57) ABSTRACT

A solid electrolytic capacitor includes a capacitor element and an exterior body that seals the capacitor element. The capacitor element includes an anode body, a dielectric layer that is formed on the surface of the anode body, a cathode part that covers at least a portion of the dielectric layer, an anode lead with one end portion electrically connected to the anode body, and a cathode lead with one end portion electrically connected to the cathode part. The other end portion of the anode lead and the other end portion of the cathode lead are drawn out from the exterior body. The cathode part includes a solid electrolyte layer that covers at least a portion of the dielectric layer. When the solid electrolytic capacitor is subjected to a processing corresponding to mounting reflow, the amount of gas generated is 1600 μL or less.

### TECHNICAL FIELD

The present disclosure relates to a solid electrolytic capacitor.

### BACKGROUND ART

A solid electrolytic capacitor includes a capacitor element and an exterior body that seals the capacitor element, for example. The capacitor element includes an anode body, a dielectric layer that is formed on the surface of the anode body, and a cathode part that covers at least a portion of the dielectric layer, for example. The cathode part includes at least a solid electrolyte layer that contains a conductive polymer covering at least a portion of the dielectric layer. In the capacitor element, one end portion of a lead is connected to the anode body and one end portion of a lead is connected to the cathode body, for example. The other end portions of the leads constitute external terminals of the solid electrolytic capacitor and are used for electrical connection to a substrate or the like.

Patent Literature 1 proposes a capacitor chip in which capacitor elements are laminated on one or both sides of a lead frame, and the obtained laminated body is sealed with a resin. In the capacitor chip, Hc-Hs is 0.1 mm or more, the ratio of Dt and Db Dt/Db is 0.1 to 9, and Dt and Db are both 0.02 mm or more, where the thickness of the laminated body is Hs, the thickness of the capacitor chip is Hc, the minimum distance from the top of the laminated body to the top surface of the sealing resin is Dt, and the minimum distance from the bottom of the laminated body to the bottom surface of the sealing resin is Db.

Patent Literature 2 proposes a solid electrolytic capacitor in which an anode oxide film layer is formed on the surface of a valve metal, a conductive functional polymer film layer is formed at a predetermined portion on the anode oxide film layer, a conductive layer is formed on the conductive functional polymer film layer, an external cathode electrode terminal is connected with the top of the conductor layer serving as a cathode part, an external anode electrode terminal is connected with the valve metal serving as an anode part, and the exterior is covered with an insulating resin material. In the solid electrolytic capacitor, a composite plating film layer is formed on the surfaces of the external cathode electrode terminal and the external anode electrode terminal, using a plating liquid of copper or an alloy of copper and tin and a coupling agent.

Patent Literature 3 proposes a solid electrolytic capacitor that includes: a capacitor element in which an insulating part is provided at a predetermined position on an anode body made of a valve metal with an anode oxide film layer formed thereon by surface roughening to separate the anode body into an anode part and a cathode formation part, and a solid electrolyte layer made of a conductive polymer and a cathode layer are sequentially laminated on an anode oxide film layer of the cathode formation part to form a cathode pail; an anode lead terminal and a cathode lead terminal that are respectively connected to an anode extraction part and the cathode layer of the capacitor element; and an insulating exterior resin that coats the capacitor element while the anode lead terminal and the cathode lead terminal are partially exposed on the outer surface. When the solid electrolytic capacitor is soldered and reflowed, a gas generated from the capacitor element is less than 0.8 μL per 1 mm³ of the conductive polymer.

### CITATION LIST

### Patent Literatures

PTL 1: International Publication No. 2007/069670
PTL 2: Japanese Laid-Open Patent Publication No. H10-289838
PTL 3: Japanese Laid-Open Patent Publication No. 2006-294843

### SUMMARY OF INVENTION

### Technical Problem

A solid electrolytic capacitor is soldered to a substrate through a reflow process in which the solid electrolytic capacitor is exposed to high temperatures, for example. During the reflow process, if gas is generated in the solid electrolytic capacitor, the internal pressure increases and the airtightness of the solid electrolytic capacitor decreases. If the airtightness decreases, air or moisture will easily enter the electrolytic capacitor, leading to a decrease in capacitor performance, Therefore, a solid electrolytic capacitor is required to have high airtightness.

### Solution to Problem

One aspect of the present disclosure relates to a solid electrolytic capacitor that includes a capacitor element and an exterior body that seals the capacitor element,
wherein the capacitor element includes an anode body, a dielectric layer that is formed on the surface of the anode body, a cathode part that covers at least a portion of the dielectric layer, an anode lead with one end portion electrically connected to the anode body, and a cathode lead with one end portion electrically connected to the cathode part.,
another end portion of the anode lead and another end portion of the cathode lead are drawn out from the exterior body,
the cathode part includes a solid electrolyte layer that covers at least a portion of the dielectric layer, and
the total amount of gas generated in the following (e) and the following (f) is 1600 μL, or less,
when the solid electrolytic capacitor is subjected to:
(a) heating at 155° C. for 24 hours;
(b) cooling to 30° C. at 60% RH or less;
(c) leaving to stand for 168 hours at 30° C. and 60% RH:
(d) cutting at the center in a length direction at 25° C. and under an inert atmosphere;
(e) heating the cut solid electrolytic capacitor to 150° C. at a rate of 50° C./min under an inert atmosphere, heating from 150° C. to 200° C. at a rate of 16.7° C./min, heating from 200° C. to 260° C. at a rate of 40° C./min, continuously heating at 260° C. for 10 seconds, and cooling from 260° C. to 30° (C at a rate of 16.7° C./min; and
(f) repeating the (e) two more times.

### Advantageous Effects of Invention

It is possible to suppress a decrease in the airtightness of a solid electrolytic capacitor when exposed to high temperatures.

### BRIEF DESCRIPTION OF DRAWINGS

FIG. 1 is a schematic cross-sectional view of a solid electrolytic capacitor according to an embodiment of the present disclosure.

FIG. 2 is a schematic cross-sectional view of a solid electrolytic capacitor according to another embodiment of the present disclosure.

### DESCRIPTION OF EMBODIMENTS

While novel features of the present invention are set forth in the appended claims, both the configuration and content of the present invention, as well as other objects and features of the present invention, will be better understood from the following detailed description given with reference to the drawings.

In a solid electrolytic capacitor, when air or moisture enters inside, the conductive polymer contained in the solid electrolyte layer may deteriorate or undergo de-doping, resulting in a decrease in the conductivity of the solid electrolyte layer, and therefore the capacitor performance decreases. A solid electrolytic capacitor is formed by sealing a capacitor element with a resin exterior body, for example. In the capacitor element, one end portion of a lead is electrically connected to the anode body and one end portion of a lead is electrically connected to cathode part, and the other end portions of the leads are drawn out from the exterior body. Accordingly, if air or moisture enters from the outside or gas generated inside is discharged through the interfaces between the leads and the exterior body, the airtightness is likely to decrease. Even if the adhesiveness of the interfaces between the leads and the exterior body is improved, if gas is generated inside, the internal pressure will increase and stress will be applied to various parts, and therefore the airtightness may decrease and the constituent members of the capacitor element may be damaged. A solid electrolytic capacitor is generally mounted on a substrate by reflow processing. In such reflow mounting processing, since the solid electrolytic capacitor is exposed to high temperatures of 220° C. or higher, for example, a large amount of gas is likely to be generated due to vaporization of moisture entering from the outside, the decomposition of low-molecular components inside, or the generation of condensed water inside. If a large amount of gas is generated inside, the airtightness of the solid electrolytic capacitor will deteriorate, which leads to a decrease in capacitor performance as described above. Therefore, solid electrolytic capacitors are required to maintain high airtightness even when exposed to high temperatures.

In view of this, (1) a solid electrolytic capacitor of the present disclosure includes a capacitor element and an exterior body that seals the capacitor element. The capacitor element includes an anode body, a dielectric layer that is formed on the surface of the anode body, a cathode part that covers at least a portion of the dielectric layer, an anode lead with one end portion connected to the anode body, and a cathode lead with one end portion electrically connected to the cathode part. Another end portion of the anode lead and another end portion of the cathode lead are each drawn out from the exterior body.

The cathode part includes a solid electrolyte layer that covers at least a portion of the dielectric layer. The total amount of gas generated in the following (e) and the following (f) is 1600 μL or less, when the solid electrolytic capacitor is subjected to:
(a) heating at 155° C. for 24 hours;
(b) cooling to 30° C. at 60% RH or less;
(c) leaving to stand for 168 hours at 30° C. and 60% RH;
(d) cutting at the center in a length direction at 25° C. and under an inert atmosphere:
(e) heating the cut solid electrolytic capacitor to 150° C. at a rate of 50° C./min under an inert atmosphere, heating from 150° C. to 200° C. at a rate of 16.7° C./min, heating from 200° C. to 260° C. at a rate of 40° C./min, continuously heating at 260° C. for 10 seconds, and cooling from 260° C. to 30° C. at a rate of 16.7° C./min; and
(f) repeating the (e) two more times.

As in aspect (1), in the present disclosure, the total amount of gas generated in the (e) and the (f) is 1600 μL or less, when the solid electrolytic capacitor having the anode lead and the cathode lead whose other end portions are drawn out from the exterior body is processed under the conditions assuming mounting reflow in the (a) to the (c) and the (e) to the (f) described above. Since the solid electrolytic capacitor has a small amount of gas generated when subjected to the mounting reflow processing, the internal pressure can be kept relatively low. Therefore, it is possible to suppress a decrease in the airtightness of the solid electrolytic capacitor when exposed to a high-temperature environment. This keeps the rate of airtightness defects of solid electrolytic capacitors at a low level.

The (a) to the (f) above are performed in the stated order. In the (c), moisture absorption processing is performed. The moisture absorption processing corresponds to moisture absorption conditions equivalent to Moisture Sensitivity Level (MSL) 3. The moisture absorption processing in the (c) simulates a state in which the solid electrolytic capacitor is stored in a high-humidity environment, assuming long-term storage in the atmosphere.

The amount of gas generated is analyzed using a thermogravimetry mass spectrometer (TG-MS) in an inert atmosphere. As the TG-MS, for example, STA 449 Jupiter F1 manufactured by NETZSCHI-Gerateba GmbH and JMS-Q1500GC manufactured by JEOL Ltd. are used in combination. The (e) and the (f) correspond to the operating conditions for the TG-MS. The inert atmosphere in the (e) means that the TG-MS measurement is performed in the inert atmosphere. The inert atmosphere is a helium gas atmosphere, for example, although this varies depending on the TG-MS. In addition, the rates in the (e) correspond to the rates of temperature increase. The solid electrolytic capacitor is heated while temperature increases at predetermined rates.

In the (d), the solid electrolytic capacitor is cut in order to measure the gas generated in the (e) to the (f), which is an operation that is not performed in normal mounting reflow processing. However, for the sake of convenience, the total amount of gas generated in the (e) and the (f) during the (a) to the (f) including the (d) will also be called “the amount of gas generated when subjected to a processing corresponding to mounting reflow” or called simply “the amount of gas generated”. The amount of gas generated is the amount gas generated per solid electrolytic capacitor. The inert atmosphere in the (d) is a helium gas atmosphere, for example.

The length direction of the solid electrolytic capacitor herein is a direction parallel to the length direction of the anode body. The length direction of the anode body refers to a direction parallel to a straight line connecting the center of the end face of one end portion of the anode body on which the cathode part is not formed and the center of the other end portion of the anode body on which the cathode part is formed, in a state in which the anode body is extended (unbent).

(2) In the above (1), the solid electrolyte layer may contain a conjugated polymer and a dopant. The dopant may include a benzenesulfonic acid compound.

(3) In the above (1), the solid electrolyte layer may contain a conjugated polymer and a dopant. The dopant may include a compound that has an aromatic ring, at least one sulfo group bonded to the aromatic ring, and at least two functional groups selected from the group consisting of a carboxy group bonded to the aromatic ring and a hydroxy group bonded to the aromatic ring.

(4) In the above (1) or (3), the solid electrolyte layer may contain a conjugated polymer and a dopant. The dopant may include a compound that has an aromatic ring, at least one sulfo group bonded to the aromatic ring, and at least two carboxy groups bonded to the aromatic ring, and does not have a hydroxy group.

(5) In the above (3) or (4), the aromatic ring may be a benzene ring.

(6) In any one of the above (1) to (5), each of the anode lead and the cathode lead may be divided into an embedded part that includes the one end portion and is embedded in the exterior body and an exposed part that includes the other end portion and is exposed from the exterior body. At least one of the anode lead and the cathode lead may have a rough surface with an interface developed area ratio Sdr of 0.4 or more. The rough surface may be present on at least a portion of the embedded part.

(7) In the above (6), each of the anode lead and the cathode lead may have the rough surface. Each of the rough surface may be present on at least a portion of the embedded part.

(8) In the above (7), the embedded part of the anode lead may have a contact surface p that is in contact with the exterior body. The embedded part of the cathode lead may have a contact surface n that is in contact with the exterior body. The percentage of the area of the rough surface in the area of the contact surface p may be 50% or more. The percentage of the area of the rough surface in the area of the contact surface n may be 50% or more.

(9) In any one of the above (6) to (8), the rough surface may be present on at least a portion of the embedded part and is present on at least a portion of the exposed part.

The solid electrolytic capacitor of the present disclosure will be described in more detail below including the above (1) to (9) with reference to the drawings as necessary. At least one of the above (1) to (9) may be combined with at least one of the elements described below as long as there is no technical contradiction.

### [Solid Electrolytic Capacitor]

The solid electrolytic capacitor of the present disclosure generates an amount of gas that is 1600 μL or less when subjected to a processing corresponding to mounting reflow. The amount of gas generated when subjected to the processing corresponding to mounting reflow may be 1550 μL or less, or may be 1,300 μL or less, or may be as low as 1,000 μL or less, for example. The amount of gas generated is preferably lower, but is difficult to reduce to 0 μL, and it may be 100 μL or more, for example.

If the amount of gas generated when subjected to the processing corresponding to mounting reflow is small as described above, even if the adhesiveness between the exterior body and the lead is high, it is possible to reduce an increase in the internal pressure of the solid electrolytic capacitor during reflow, and reduce a decrease in airtightness. Since the airtightness defect rate is reduced, productivity can be increased, and this is advantageous in terms of cost as well. In addition, since excellent airtightness of the solid electrolytic capacitor can be ensured, it is possible to suppress a decrease in capacitor performance, such as an increase in the equivalent series resistance (ESR) or a decrease in electrostatic capacitance, resulting in an improvement in reliability.

The amount of gas generated when subjected to the processing corresponding to mounting reflow can be regulated by selecting or adjusting at least one selected from the group consisting of the method of forming the solid electrolyte layer, the kinds of components (for example, dopants or additives) used to form the solid electrolyte layer, the drying conditions of the capacitor element, and the degree of adhesiveness between the lead and the exterior body (for example, the surface roughness of the lead).

The solid electrolytic capacitor includes one or more capacitor elements. The capacitor element is sealed with the exterior body. The solid electrolytic capacitor also includes an anode lead and a cathode lead that are electrically connected to the anode body and the cathode part of the capacitor element, respectively.

### (Capacitor Element)

### (Anode Body)

The anode body included in the capacitor element may contain a valve metal, an alloy containing a valve metal, a compound containing a valve metal, and the like. The anode body may include one kind of these materials or may include two or more kinds of these materials in combination. Examples of the valve metal include aluminum, tantalum, niobium, and titanium.

The anode body normally has a porous part on at least the surface layer. With the porous part, the anode body has protrusions and recesses on at least the surface. The anode body with the porous part on the surface layer can be obtained by roughening the surface of a base material (sheet-like (for example, foil-like or plate-like) base material or the like) containing a valve metal, for example. Roughening may be performed by etching or the like, for example. The anode body may be a formed body of particles containing a valve metal or its sintered body. Each of the formed body and the sintered body may entirely constitute the porous part. Each of the formed body and the sintered body may have a sheet-like shape or may have a rectangular parallelepiped shape, a cubic shape, or a shape similar thereto.

The anode body is divided into a second part where the cathode part is formed with a dielectric layer in between, and a first part that is another part. The second part is also called a cathode formation part, and the first part is also called an anode extraction part. The porous part may be formed at the second part, or may be formed at the second part and the first part. The first part is used for electrical connection with an external electrode on the anode side. For example, one end portion of the anode lead is electrically connected to the first part, and the other end portion of the anode lead is drawn out from the exterior body and is electrically connected to the external electrode.

Herein, the end portion of the first part of the anode body may be called a first end portion, and the end portion of the second part of the anode body may be called a second end portion.

A separation part (also called an insulating region) may be provided near the end portion of the first part of the anode body on the second part side to insulate the anode body and the cathode part. The separation part may be formed by adhering insulating tape or the like, or by causing an insulating resin to permeate the porous part, or by a combination of these.

### (Dielectric Layer)

The dielectric layer is formed to cover the surface of at least a portion of the anode body, for example. The dielectric layer is an insulating layer that functions as a dielectric body. The dielectric layer is formed by subjecting the valve metal on the surface of the anode body to anode oxidation through chemical conversion treatment or the like. Since the dielectric layer is formed on the porous surface of the anode body, the surface of the dielectric layer has minute protruding and recessed shapes as described above.

The dielectric layer contains an oxide of a valve metal. For example, when tantalum is used as the valve metal, the dielectric layer contains Ta₂O₅, and when aluminum is used as the valve metal, the dielectric layer contains Al₂O₃. The dielectric layer is not limited to these examples and may simply function as a dielectric body.

### (Cathode Part)

The cathode part is formed to cover at least a portion of the dielectric layer formed on the surface of the anode body. Each layer constituting the cathode part can be formed by a known method in accordance with its layer configuration of the cathode part.

The cathode part includes a solid electrolyte layer that covers at least a portion of the dielectric layer and a cathode extraction layer that covers at least a portion of the solid electrolyte layer, for example.

Hereinafter, component elements of the cathode part will be described.

### (Solid Electrolyte Layer)

The solid electrolyte layer is formed on the surface of the anode body to cover the dielectric layer with the dielectric layer in between. The solid electrolyte layer is not necessarily required to cover the entire dielectric layer (entire surface), and is formed to cover at least a portion of the dielectric layer. The solid electrolyte layer constitutes at least a portion of the cathode part in the solid electrolytic capacitor.

The solid electrolyte layer contains a conductive polymer. The conductive polymer includes, for example, a conjugated polymer and a dopant. The solid electrolyte layer may further contain an additive as necessary.

The conjugated polymer may be a known conjugated polymer used in a solid electrolytic capacitor, such as a π-conjugated polymer, for example. Examples of the conjugated polymer include polymers having a basic skeleton of polypyrrole, polythiophene, polyaniline, polyfuran, polyacetylene, polyphenylene, polyphenylene vinylene, polyacene, or polythiophene vinylene. Among them, polymers having a basic skeleton of polypyrrole, polythiophene, or polyaniline are preferable. The above polymer contains at least one kind of monomer unit constituting the basic skeleton. The monomer unit also includes a monomer unit having a substituent group. The above polymer includes a homopolymer and a copolymer of two or more kinds of monomers. For example, polythiophene may include poly(3,4-ethylenedioxythiophene) (PEDOT) and the like.

The solid electrolyte layer may contain one kind of a conjugated polymer or may contain a combination of two or more kinds of conjugated polymers.

The weight-average molecular weight (Mw) of the conjugated polymer is not limited in particular, and is 1,000 or more and 1,000,000 or less, for example.

The weight-average molecular weight (Mw) herein takes a polystyrene-equivalent value measured by gel permeation chromatography (GPC). The GPC measurement is generally performed using a polystyrene gel column and water/methanol (a volume ratio of 8/2) as a mobile phase.

Examples of the dopant include at least one selected from the group consisting of anion and polyanion.

Examples of the anions include sulfate ion, nitrate ion, phosphate ion, borate ion, organic sulfonate ions, and carboxylate ion. Compounds that generate these anions may be used as dopants. For example, dopants that generate sulfate ion may be aromatic sulfonic acid compounds (such as benzenesulfonic acid compounds and naphthalene sulfonic acid compounds).

Aromatic sulfonic acid compounds are lower in molecular weight than polymer anions described below, and therefore they tend to easily decompose and their decomposition products tend to easily evaporate. However, benzenesulfonic acid compounds are likely to come close to conjugated polymers and form complexes with the conjugated polymers and are likely to be suppressed from de-doping, as compared to aromatic compounds with large aromatic rings such as naphthalene sulfonic acid compounds. Furthermore, benzenesulfonic acid compounds are likely to be suppressed from decomposition, depending on the structure of the compound including the functional groups described later. Due to the relatively low amount of undoped or de-doped compounds, it is possible to suppress an increase in the amount of gas generated due to the decomposition of these compounds.

The dopant may be an aromatic sulfonic acid compound that has at least one sulfo group bonded to an aromatic ring and at least one (preferably at least two) functional group selected from the group consisting of a carboxy group bonded to the aromatic ring and a hydroxy group bonded to the aromatic ring. Such a compound may hereinafter be called an aromatic sulfonic acid compound IA. In the aromatic sulfonic acid compound IA, the aromatic ring may be an aromatic heterocycle, but is preferably an aromatic hydrocarbon ring. The aromatic hydrocarbon ring is preferably an aromatic hydrocarbon ring having 6 to 14 carbon atoms (preferably 6 to 10 carbon atoms) such as a benzene ring or a naphthalene ring. In the aromatic sulfonic acid compound having the above functional group, the positions of the sulfo group and the functional group are close to each other on the aromatic ring, and therefore the compound is likely to come close to the conjugated polymer and be doped with the conjugated polymer, and is unlikely to be de-doped from the conjugated polymer. In addition, the compound is relatively high in thermal stability due to the presence of the functional group. These make it easier to suppress the decomposition of the dopant. Therefore, the amount of gas generated can be further suppressed. In particular, if the aromatic ring is a benzene ring, the positions of the sulfo group and the functional group are closer, and the compound is even more likely to be doped with the conjugated polymer and is more unlikely to be de-doped from the conjugated polymer, which is more preferable. However, if the aromatic sulfonic acid compound contains a hydroxy group, condensed water may be generated when it is exposed to a high temperature of approximately 185° C. or higher, which may increase the amount of gas generated. Therefore, from the viewpoint of suppressing the generation of condensed water, an aromatic sulfonic acid compound without a hydroxy group may be used. Such a compound is preferably a compound that has an aromatic ring, at least one sulfonic acid group bonded to the aromatic ring, and at least two carboxy groups bonded to the aromatic ring. Among aromatic sulfonic acid compounds IA, a compound having a benzene ring as an aromatic ring will also be called a benzene sulfonic acid compound Ia, and a compound having a naphthalene ring as an aromatic ring will also be called a naphthalene sulfonic acid compound Ib. In addition, among aromatic sulfonic acid compounds IA, a compound that has at least one sulfo group bonded to the aromatic ring and at least two carboxylic acid groups bonded to the aromatic ring, and does not have a hydroxyl group, will also be called an aromatic sulfonic acid compound Ic. The aromatic sulfonic acid compound may have one or two or more sulfo groups. From the viewpoint of easily suppressing corrosion of metal members included inside the solid electrolytic capacitor, the number of sulfo groups in the aromatic sulfonic acid compound IA may be two or less, or may be one. Depending on the number of members (or number of carbon atoms) in the aromatic ring, the number of the above functional groups in the aromatic sulfonic acid compound IA may be 4 or less, or may be 3 or less.

Among aromatic sulfonic acid compounds, a benzene sulfonic acid compound or the aromatic sulfonic acid compound IA is preferred. Such an aromatic sulfonic acid compound is preferably a benzene sulfonic acid compound (for example, a benzene sulfonic acid compound Ia such as 5-sulfoisophthalic acid, 4-sulfophthalic acid, 5-sulfosalic acid, or 4-hydroxy-5-sulfoisophthalic acid), a naphthalene sulfonic acid compound Ib (for example, a sulfonaphthalene dicarboxylic acid (such as 5,7-disulfo-2,3-naphthalene dicarboxylic acid), or a hydroxysulfonaphthoic acid). Among these, a benzene sulfonic acid compound Ia such as 5-sulfoisophthalic acid or 5-sulfosarichylic acid is preferred. From the viewpoint of further suppressing the amount of gas generated, an aromatic sulfonic acid compound Ic (for example, 5-sulfoisophthalic acid, 4-sulfophthalic acid, or a sulfonaftalenedicarbonic acid) may be used. One type of an aromatic sulfonic acid compound may be used alone, or two or more types of aromatic sulfonic acid compounds may be used in combination. The benzene sulfonic acid compound or the aromatic sulfonic acid compound IA may be used in combination with other dopants as needed. In addition, the benzene sulfonic acid compound Ia and the naphthalene sulfonic acid compound Ib may be used in combination. The percentage of the benzene sulfonic acid compound (or the benzene sulfonic acid compound Ia) in the entire dopant exceeds 50% by mass, for example, and may be 70% by mass or more, 80% by mass or more, or 90% by mass or more. The percentage of the benzenesulfonic acid compound (or the benzene sulfonic acid compound Ia) in the entire dopant is 100% by mass or less. In addition, the percentage of the aromatic sulfonic acid compound IA in the entire dopant may be within such a range.

The polyanion may be a polymer anion or the like. The solid electrolyte layer may include a conjugated polymer and a polymer anion, for example. In this case, as the conjugated polymer, a conjugated polymer containing a monomer unit corresponding to a thiophene compound may be used.

The polymer anion may be a polymer having a plurality of anionic groups, for example. Such a polymer may be a polymer containing a monomer unit with anionic groups. Examples of the anionic group include a sulfonic acid group, a carboxy group, and the like.

Examples of the polymer anion having a carboxy group include, but are not limited to, a copolymer using a polyacrylic acid, a polymethacrylic acid, or at least one of an acrylic acid and a methacrylic acid.

Specific examples of the polymer anion having a sulfonic acid group include, but are not limited to, polymer type polysulfonic acids such as polyvinyl sulfonic acids, polystyrene sulfonic acids (including copolymers and substitution products with substituents), polyarylsulfonic acids, polyacrylsulfonic acids, polymethacrylsulfonic acids, poly(2-acrylamido-2-methylpropanesulfonic acid), polyisoprenesulfonic acids, polyester sulfonic acids (such as aromatic polyester sulfonic acids), and phenol sulfonic acid novolac resins.

In the solid electrolyte layer, the anionic group of the dopant may be contained in a free form, an anion form, or a salt form, or may be contained in a form bound to or interacted with the conjugated polymer. Herein, all groups of these forms may be simply called “anionic group,” “sulfonic acid group,” or “carboxy group.” The hydroxy group bonded to the benzene ring is a phenolic hydroxy group and may be contained in free form (—OH), anionic form (—O—), or salt form. All groups of these forms may be simply called “hydroxy group”. These salts may be salts of an anion and either an organic base (such as organic amine or organic ammonium) or an inorganic base (such as metal hydroxide or ammonia).

The amount of dopant contained in the solid electrolyte layer is 10 parts by mass or more and 1000 parts by mass or less, for example, or may be 20 parts by mass or more and 500 parts by mass or less, or may be 50 parts by mass or more and 200 parts by mass or less, with respect to 100 parts by mass of the conjugated polymer.

The solid electrolyte layer may further contain, as necessary, at least one selected from the group consisting of known additives and known conductive materials other than conductive polymers. Examples of the conductive materials include at least one selected from the group consisting of conductive inorganic materials such as manganese dioxide and TCNQ complex salts.

A layer for improving adhesiveness may be interposed between the dielectric layer and the solid electrolyte layer.

The solid electrolyte layer may be a single layer or may be constituted of multiple layers. For example, the solid electrolyte layer may include a first solid electrolyte layer that covers at least a portion of the dielectric layer and a second solid electrolyte layer that covers at least a portion of the first solid electrolyte layer. The kinds, compositions, and contents of the conjugated polymer, dopant, and additives contained in these layers may be different or the same between the layers.

The solid electrolyte layer is formed by polymerizing a precursor of the conjugated polymer on the dielectric layer using a processing liquid containing the precursor and the dopant, for example. The polymerization can be performed by at least either of chemical polymerization and electrolytic polymerization. The precursor of the conjugated polymer may be a monomer, an oligomer, a prepolymer, or the like. The solid electrolyte layer may be formed by applying a processing liquid containing a conductive polymer (for example, a dispersion liquid or a solution) to the dielectric layer and then drying the liquid. The dispersion medium (or solvent) may be at least one selected from the group consisting of water and organic solvents, for example. The processing liquid may further contain another component (at least one selected from the group consisting of dopants and additives). For example, the solid electrolyte layer may be formed using a processing liquid containing a conductive polymer (for example, PEDOT), a dopant (for example, a polyanion such as a polystyrene sulfonic acid), and an additive, as necessary.

For example, the first solid electrolyte layer may be formed by polymerization using a processing liquid containing a conductive polymer precursor and a dopant, and then the second solid electrolyte layer may be formed using a processing liquid containing a conductive polymer and, if necessary, a dopant.

When using a processing liquid containing a precursor of a conjugated polymer, an oxidant is used to polymerize the precursor. The oxidant may be contained as an additive in the processing liquid. The oxidant may be applied to the anode body before or after the processing liquid is brought into contact with the anode body on which the dielectric layer is formed. Examples of the oxidant include compounds capable of generating Fe³⁺ (such as ferric sulfate), persulfates (such as sodium persulfate and ammonium persulfate), and hydrogen peroxide. The oxidant may be of one kind or two or more kinds in combination.

The step of forming the solid electrolyte layer by immersion in the processing liquid and polymerization (or drying) may be performed once or may be repeated more than once. In the iterations of the step, conditions such as the composition and viscosity of the processing liquid may be the same or at least one condition may be made different.

When forming at least a portion of the solid electrolyte layer using a processing liquid (the containing a conjugated polymer precursor, a relatively low molecular weight component (for example, a low molecular weight dopant (for example, an aromatic sulfonic acid compound)) is often utilized, as compared to using a processing liquid containing a conductive polymer (the above dispersion liquid or solution). In addition, since in-situ polymerization is performed, residues of unreacted precursors, dopants, relatively low-molecular polymers, side reactants, oxidizing agents, catalysts, and the like tend to remain in the solid electrolyte layer. Therefore, the reflow processing tends to generate a lot of gas and the airtightness tends to deteriorate. In the present disclosure, even in such cases, it is possible to reduce the amount of gas generated when subjected to the processing corresponding to mounting reflow, and to ensure high airtightness by adjusting at least one of the types of components such as dopants and the drying conditions of the capacitor element, for example.

### (Cathode Extraction Layer)

The cathode extraction layer need only include at least a first layer that is in contact with the solid electrolyte layer and covers at least a portion of the solid electrolyte layer, and may include the first layer and a second layer that covers the first layer. Examples of the first layer include a layer containing conductive particles, a metal foil, and the like. Examples of the conductive particles include at least one selected from conductive carbon and a metal powder. For example, the cathode extraction layer may be constituted of a layer containing conductive carbon (also referred to as a carbon layer) as the first layer, and a metal foil or a layer containing a metal powder as the second layer. In the case of using a metal foil as the first layer, the cathode extraction layer may be constituted of the metal foil.

Examples of the conductive carbon include graphite (artificial graphite, natural graphite, or the like).

The layer containing a metal powder serving as the second layer can be formed by laminating a composition containing a metal powder on the surface of the first layer, for example. Examples of such a second layer include a metal paste layer formed using a composition containing a metal powder such as silver particles and a resin (binder resin). Although a thermoplastic resin can be used as the resin, it is preferable to use a thermosetting resin such as an imide resin or an epoxy resin.

In the case of using a metal foil as the first layer, there are no particular limitations on the type of metal, but it is preferable to use a valve metal such as aluminum, tantalum, niobium, or an alloy containing a valve metal. If necessary, the surface of the metal foil may be roughened. The surface of the metal foil may be provided with a chemical conversion coating, or may be provided with a coating made of a metal different from the metal constituting the metal foil (dissimilar metal) or a non-metal coating. Examples of dissimilar metals and non-metals include metals such as titanium and non-metals such as carbon (e.g., conductive carbon).

The above dissimilar metal or non-metal (e.g., conductive carbon) coating may be used as the first layer, and the above-described metal foil may be used as the second layer.

### (Separator)

In the case of using a metal foil in the cathode extraction layer, a separator may be placed between the metal foil and the anode foil. There are no particular limitations on the separator, and for example, it is possible to use a nonwoven fabric containing fibers of cellulose, polyethylene terephthalate, vinylon, polyamide (e.g., aliphatic polyamide, aromatic polyamide such as aramid), or the like.

### (Anode Lead and Cathode Lead)

In the capacitor element, one end portion of the anode lead is electrically connected to the anode body (specifically, the first part), and the other end is drawn out from the exterior body. One end portion of the cathode lead is electrically connected to the cathode part (for example, the cathode extraction layer), and the other end is drawn out from the exterior body. Each lead is divided into an embedded part that includes the one end portion and is embedded in the exterior body, and an exposed part that includes the other end portion and is exposed from the exterior body. The part of each lead that includes the other end portion and is exposed from the exterior body is used for solder connection to the substrate on which the solid electrolytic capacitor is to be mounted.

The lead and the anode body may be connected by welding, for example. The anode parts (specifically, the first parts) of the plurality of capacitor elements may be connected by welding or the like, and the leads may be connected by welding or the like. The lead and the cathode part may be connected using a conductive adhesive or may be connected using solder, for example. In addition, the cathode lead may be connected to the cathode part by welding (such as resistance welding or laser welding). The conductive adhesive is a mixture of a curable resin and conductive particles (such as carbon particles and metal particles such as silver particles), for example.

Each lead may be a lead wire or a lead frame. When using a lead frame, the adhesiveness between the lead and the exterior body can be easily improved by roughening the surface.

At least one of the anode lead and the cathode lead preferably has a rough surface. From the viewpoint of ensuring higher adhesiveness between the lead and the exterior body, the rough surface of the lead is preferably present on at least the embedded part. The rough surface may be present not only on the embedded part but also on the exposed part. The rough surface of the lead preferably has an interface developed area ratio Sdr of 0.4 or more, and more preferably 0.5 or more, or 0.6 or more. Herein, the rough surface with an Sdr in this range will also be called a rough surface (R). If the Sdr is within the above range, the effect of suppressing external air or moisture from entering the solid electrolytic capacitor can be improved. On the other hand, if the Sdr is within the above range and a large amount of gas is generated inside, the internal pressure will become excessively high and the airtightness will be likely to deteriorate. In the present disclosure, as described above, reducing the amount of gas generated when subjected to the processing corresponding to mounting reflow curbs the increase in the internal pressure during actual reflow processing and suppresses a decrease in the airtightness even when Sdr is high as described above. Although there is no particular upper limit of Sdr, Sdr may be 10 or less, 3 or less, or 1 or less, from the viewpoint of easily manufacturing leads. Sdr may be 0.4 or more and 10 or less (or 3 or less), 0.5 or more and 3 or less (or 1 or less), or 0.6 or more and 3 or less (or 1 or less), for example.

The interface developed area ratio Sdr is a parameter that is measured in conformity with ISO25178. For example, the Sdr of a completely flat surface is 0.

Surface roughness is generally expressed by various indices such as the arithmetic mean roughness Sa. The degree of adhesiveness between the lead and the exterior body and the airtightness defect rate have a low correlation with the arithmetic mean roughness Sa and the like, but have a relatively high correlation with the interface developed area ratio Sdr. Therefore, using Sdr as an index, roughening the surface of the lead (at least a portion of the surface of the lead in contact with the exterior body) is advantageous in increasing the adhesiveness and airtightness between the lead and the exterior body.

At least one of the anode lead and the cathode lead may have a rough surface (RI. Preferably, each of the leads has a rough surface (R). The rough surface (R) may be formed on the entire lead surface. In the case of joining the lead by welding, for example, the rough surface (R) may be formed on the entire surface of the lead excluding the welded part. From the viewpoint of ensuring high adhesiveness with the exterior body, it is preferred that the lead has the rough surface (R) on at least the embedded part (especially the surface that is in contact with the exterior body). The lead may have the rough surface (R) on at least a portion of the embedded part. In addition to the embedded part, the lead may also have the rough surface (R) on at least a portion of the exposed part.

The rough surface (R) may extend from the embedded part to the exposed part so that it is also formed on at least a portion of the exposed part. At the time of sealing with the exterior body, the outer surface of the exterior body may be shifted. Due to the rough surface (R) being formed so as to extend from the embedded part to the exposed part, the embedded part can reliably have the rough surface (R).

If the rough surface (R) is also formed on the exposed part, there is no particular limitation on the extent to which the rough surface (R) is formed. The length of the rough surface (R) from the boundary between the embedded part and the exposed part (that is, the contact part between the exposed part and the exterior body) is preferably 0.3 mm or more, and may be 0.5 mm or more. The length of the rough surface (R) here is the length along the surface of the exposed part, which is the apparent length assuming that the surface of the exposed part is smooth. There is no particular limitation on the upper limit of the length of the rough surface (R), and the entire surface of the exposed part may be the rough surface (R).

Increasing the proportion of the rough surface (R) in the contact surface further improves the adhesiveness between the lead and the exterior body, and further reduces the airtightness defect rate. The contact surface where the embedded part of the anode lead comes into contact with the exterior body will be called a contact surface p, and the contact surface where the embedded part of the cathode lead comes into contact with the exterior body will be called a contact surface n. The percentage of the area of the rough surface (R) in the area of the contact surface p may be 50% or more, may be 60% or more or 70% or more, or may be 80% or more (for example, 90% or more). The percentage of the area of the rough surface (R) in the area of the contact surface n may be 50% or more, may be 60% or more or 70% or more, or may be 80% or more (for example, 90% or more), The percentage of the area of the rough surface (R) in the area of each of the contact surface p and the contact surface n is 100% or less. The contact surface p and the contact surface n may all be rough surfaces (R).

The surface of the lead may have the rough surface (R) other than the contact surface that is in contact with the exterior body. For example, among the surfaces of the cathode lead, the surface that is electrically connected to the cathode part may have the rough surface (R). The percentage of the area of the rough surface (R) in the surface area of the embedded part may be 50% or more, 60% or more, 70% or more, 80% or more, or 90% or more. The percentage of the area of the rough surface (R) in the surface area of the embedded part is 100% or less. The entire surface of the embedded part may be a rough surface (R).

The surface area of the embedded part and the area of the contact surface are apparent surface areas, and are surface areas based on the assumption that the surfaces are smooth. The area of the rough surface (R) is the apparent surface area of the part where the rough surface (R,) is formed, and is a surface area based on the assumption that the surface is smooth.

A preferred example of the solid electrolytic capacitor according to the present disclosure satisfies the following conditions (I) and (II), and may further satisfy condition ((I):

(I) The percentage of the area of the rough surface (R) in the area of the contact surface p and the percentage of the area of the rough surface (R) in the area of the contact surface n are both 50% or more, or may be 60% or more or 70% or more, or may be 80% or more (for example, 90% or more). The percentage of the area of the rough surface (R) in the area of the contact surface p and the percentage of the area of the rough surface (R) in the area of the contact surface n is 100% or less. The contact surface p and the contact surface n may all be rough surfaces (R). Under the condition (I), the area of the contact surface p and the area of the contact surface n may be respectively called the area of the embedded part of the anode lead and the area of the embedded part of the cathode lead.

(II) The interface developed area ratio of the rough surface (R) is 0.4 or more, or may be 0.5 or more or 0.6 or more. The interface developed area ratio may be 10 or less, or may be within the above range.

(III) The rough surface (R) is formed from the boundary between the embedded part and the exposed part to the inside of the exterior body. The rough surface (R) may extend from the embedded part to the exposed part so that it is also formed on at least a portion of the exposed part.

The lead with the rough surface (R) can be obtained through a step (a) of processing a metal sheet as a base material into a predetermined shape by pressing or the like, and a step (b) of forming the rough surface (R), for example. Either the step (a) or the step (b) can be performed first. In the step (a), the metal sheet can be processed using a known method.

The step (b) of forming the rough surface (R) may be performed through sandblasting, roughening plating, roughening etching, or the like, for example. The sandblasting method is preferred because it enables quick processing and is excellent in cost performance. The rough plating method is preferred because of its low cost. The roughening etching method is preferred because it causes less unevenness and can provide fine roughness. The roughening plating method and the roughening etching method are advantageous in that beads (projection material) do not remain, unlike with the sandblasting method.

Decreasing the particle size of the particles (projection material) (for example, increasing the count) increases the interface developed area ratio Sdr of the sandblasted surface. Therefore, in this method, sandblasting is usually performed using particles smaller than those traditionally used for roughening the lead. In addition, increasing the number of sandblasting shots increases the Sdr of the sandblasted surface to some extent. If the particle size of the particles (projection material) is excessively decreased, the Sdr may become small. However, the conditions under which the Sdr of the rough surface falls within the above range can be easily determined by experiment. There is no particular limitation on the particles (projection material) used for sandblasting, and at least one of alumina particles and garnet particles may be used.

When forming the rough surface (R) using the roughening plating method, the Sdr can be made within the above range by, for example, forming acicular or particulate plating to increase the surface area. For example, the percentage of acicular or particulate plating may be increased.

When forming the rough surface (R) using the roughening etching method, the surface area can be increased by forming a roughened shape by utilizing the difference between the etching rate of crystal grain boundaries and the etching rate of crystal grains (the etching rate of crystal grain boundaries is higher), for example. This enables the Sdr to fall within the above range. For example, the ratio of the crystal grain boundaries to the crystal grains in the metal that is the lead material may be changed by selecting the metal, and the difference in etching rate may be altered by changing the etching conditions.

At least one of the base materials selected from the base material of the anode lead and the base material of the cathode lead may be a copper base material (copper, copper alloy, or the like). In that case, at least a portion of the copper base material in the exposed part may be coated with a copper plating layer. In one preferred example, the base material of the anode lead and the base material of the cathode lead are both copper base materials. In that case, at least a portion of each copper base material may be coated with a copper plating layer. The entire surface of the exposed part may be coated with a copper plating layer. A rolled copper plate can be used as the copper base material (lead frame).

The solid electrolytic capacitor (more specifically, the lead) according to the present embodiment may further include a tin plating layer that covers the copper plating layer. In this case, the solid electrolytic capacitor (more specifically, the lead) may further include another layer that is arranged between the copper plating layer and the tin plating layer. The other layer may be an alloy layer of copper and tin or a nickel plating layer. The tin plating layer can improve solder wettability and improve the reliability of the electrical connection between the solid electrolytic capacitor and the external substrate. If a tin plating layer is formed on the copper plating layer, tin (Sn) in the tin plating layer may be diffused into the copper plating layer due to the heat during mounting, and an alloy layer of copper and tin may be formed between the copper plating layer and the tin plating layer. A nickel plating layer may be formed between the copper plating layer and the tin plating layer.

The solid electrolytic capacitor (more specifically, the lead) according to the present embodiment may further include a precious metal plating layer that covers the copper plating layer. The precious metal plating layer may contain at least one selected from the group consisting of gold, platinum, and palladium.

The solid electrolytic capacitor (more specifically, the lead) according to the present embodiment may further include a nickel plating layer that is arranged between the copper plating layer and the precious metal plating layer.

In the following description, the layer formed on the lead base material (such as the plating layer described above) will also be called a “coating layer”.

In the case of forming a coating layer such as a plating layer, as long as the rough surface (R) is finally forned in a predetermined region, there is no particular limitation on the order of the steps (a) and (b), and the step (c) of forming a coating layer. However, if a coating layer is formed on the surface including the rough surface (R) after formation of the rough surface (R), the interface developed area ratio Sdr of the rough surface (R) may decrease. In that case, the step (b) is performed after the step (c). Alternatively, after forming the rough surface (R) in the step (b), the step (c) of forming a coating layer may be performed only on regions that do not need to have the rough surface (R). The step (c) may be performed before the step of covering the capacitor element and the lead embedded part with the exterior body. Alternatively, after the step of covering with the exterior body, the step (c) may be performed to form the coating layer only on the exposed part of the lead.

(Exterior body) The solid electrolytic capacitor includes the exterior body that covers the capacitor element. The exterior body also covers a portion of the anode lead (embedded part) and a portion of the cathode lead (embedded part). The exterior body preferably contains a cured curable resin composition, and may contain a thermoplastic resin or a composition containing the same. The curable resin composition may contain a curable resin and a filler. The curable resin is preferably a thermosetting resin.

The curable resin composition may contain, in addition to the curable resin, a filler, a curing agent, a polymerization initiator, a catalyst, and the like. Examples of the curable resin include epoxy resins, phenol resins, urea resins, and polyimide, polyamide imide, polyurethane, diallyl phthalate, unsaturated polyesters, and the like. The curable resin composition may contain a plurality of curable resins.

Examples of the filler include insulating particles (inorganic particles and organic particles), insulating fibers, and the like. Examples of the insulating material that constitutes the filler include insulating compounds such as silica and alumina (such as oxides), glass, mineral materials (such as talc, mica, and clay), and the like. The exterior body may contain only one type or two or more types of fillers. The content of the filler in the exterior body may be in the range of 10 to 90% by mass.

The thermoplastic resin may be polyphenylene sulfide (PPS), polybutylene terephthalate (PBT), or the like, for example. The composition containing the thermoplastic resin may contain, in addition to the thermoplastic resin, the above-mentioned filler and the like.

The capacitor element can be sealed with the exterior body by putting the capacitor element and a material resin for the exterior body (for example, an uncured thermosetting resin and a filler) into a molding die and performing transfer molding, injection molding, compression molding, or the like, for example. At this time, the capacitor element is sealed while the other end portion of the anode lead electrically connected to the anode body and the other end portion of the cathode lead electrically connected to the cathode are exposed from the molding die.

### (Others)

The amount of gas generated when subjected to the processing corresponding to mounting reflow is performed can also be reduced by the drying process of the capacitor element as described above. The drying process is particularly suitable when the solid electrolytic capacitor contains a large amount of components that can be gasified (for example, residues of the above-mentioned unreacted precursors, relatively low-molecular dopants, relatively low-molecular polymers, side reactants, oxidizing agents, and catalysts, and components that generate condensed water). The drying process can be performed at temperatures of more than 160° C. and 230° C. or less (preferably 185° C. or more and 220° C. or less, or 210° C. or less), for example. By performing the drying process at such a temperature, condensed water can be generated, and even if components that easily vaporize, such as moisture, are contained inside, they can be gasified and removed, while deterioration of the conductive polymer is suppressed. Accordingly, the amount of gas generated when subjected to the processing corresponding to mounting reflow can be reduced. This makes it possible to ensure high airtightness when actual reflow processing is performed. The drying process may be performed for four hours or more and 60 hours or less, for 10 hours or more and 50 hours or less, or for 15 hours or more and 45 hours or less, for example. Performing the drying process for such a period of time reduces the amount of gas generated during actual reflow processing and ensure high airtightness. Drying may be performed under an inert atmosphere (for example, under an atmosphere or flow of an inert gas such as helium, nitrogen, or argon).

The solid electrolytic capacitor may be of a wound type, a chip type, or a laminated type. For example, the solid electrolytic capacitor may include two or more wound capacitor elements or may include two or more laminated capacitor elements. The configuration of the capacitor elements can be selected depending on the type of the solid electrolytic capacitor.

The solid electrolytic capacitor may further include a case arranged outside the exterior body (resin composition) as necessary. The resin material constituting the case may be a thermoplastic resin or a composition containing the same. The metal material constituting the case may be a metal such as aluminum, copper, or iron, or alloys of these metals (including stainless steel, brass, and the like), for example.

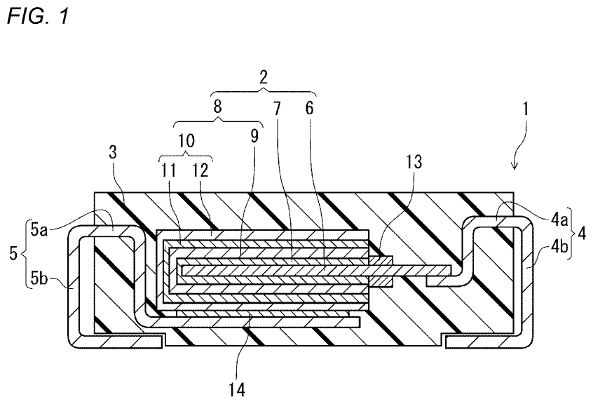

FIG. 1 is a schematic cross-sectional view of a structure of a solid electrolytic capacitor according to an embodiment of the present disclosure. As shown in FIG. 1, a solid electrolytic capacitor 1 includes a capacitor element 2, a resin exterior body 3 that seals the capacitor element 2, and an anode lead 4 and a cathode lead 5, each of which is at least partially exposed to the outside of the exterior body 3. The anode lead 4 and the cathode lead 5 can be constituted of a metal such as copper or a copper alloy, for example. The exterior body 3 has an outer shape that is approximately rectangular parallelepiped-shaped, and the solid electrolytic capacitor 1 also has an outer shape that is approximately rectangular parallelepiped-shaped.

The capacitor element 2 includes an anode body 6, a dielectric layer 7 that covers the anode body 6, and a cathode part 8 that covers the dielectric layer 7. The cathode part 8 includes a solid electrolyte layer 9 that covers the dielectric layer 7 and a cathode extraction layer 10 that covers the solid electrolyte layer 9. The cathode extraction layer 10 includes a first layer 11 that covers the solid electrolyte layer 9 and a second layer 12 that covers the first layer.

The anode body 6 includes a region (a second part) that faces the cathode part 8 and a region (a first part) that does not face the cathode part 8. An insulating separation part 13 is formed at a portion of the first part of the anode body 6 adjacent to the cathode part 8 so as to cover the surface of the anode body 6 in a band shape, thereby restricting the contact between the cathode part 8 and the anode body 6 (specifically, the first part). One end portion of the anode lead 4 is electrically connected by welding to a portion of the first part of the anode body 6. A portion including one end portion of the cathode lead 5 is electrically connected to the cathode part 8 via an adhesive layer 14 made of a conductive adhesive. The other end portions of the anode lead 4 and the cathode lead 5 are exposed from the exterior body 3. The anode lead 4 and the cathode lead 5 are respectively divided into embedded parts 4a and 5a that are embedded in the exterior body 3 on one end side, and exposed parts 4b and 5b that are exposed from the exterior body 3 on the other end side. The other end portions of the anode lead 4 and the cathode lead 5 are soldered to a substrate or the like.

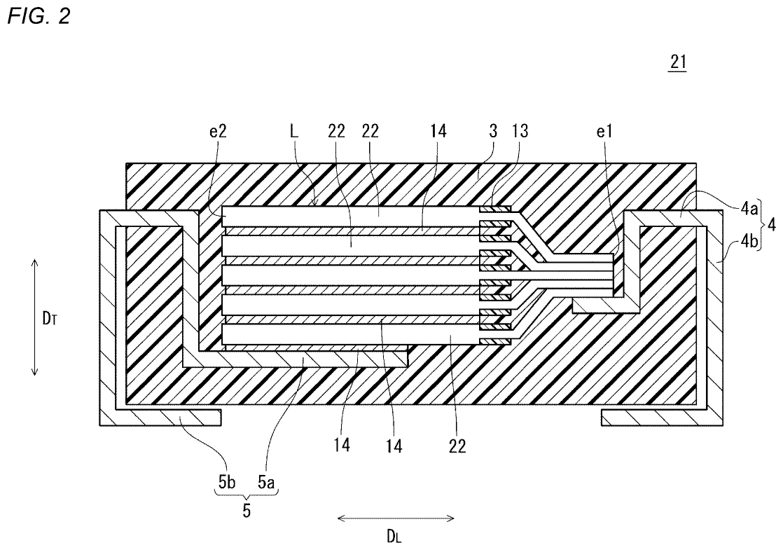

FIG. 2 is a schematic cross-sectional view of a solid electrolytic capacitor according to another embodiment of the present disclosure. A solid electrolytic capacitor 21 includes a plurality of laminated capacitor elements 22 (a laminated body L), a resin exterior body 3 that seals the laminated body L, and an anode lead 4 and a cathode lead 5, each of which is at least partially exposed to the outside of the exterior body 3. FIG. 2 is a schematic cross-sectional view of the solid electrolytic capacitor 21 in a direction parallel to a length direction and a thickness direction (laminating direction) D_{T} of the capacitor elements 22.

In the laminated body L, one first end portion e1 (end portion on the first part side) of an anode body 6 included in each capacitor element 22 is electrically connected in a bundled state to one end portion of the anode lead 4 by welding. One end portion of a cathode lead 5 is electrically connected to the cathode part of the capacitor element 22 arranged at the outermost side of the laminated body L (the bottom end in the drawing) via an adhesive layer 14 formed of a conductive adhesive. The other end portion of the anode lead 4 and the other end portion of the cathode lead 5 are each extracted from another main surface of the exterior body 3 to form exposed parts 4b and 5b, respectively. For the configurations illustrated in FIG. 2 except for the above, the description of FIG. 1 can be referred to. FIG. 2 does not illustrate the configuration of the capacitor elements

### Examples

Hereinafter, the present invention will be specifically described with reference to examples and comparative examples. However, the present invention is not limited to the following examples.

<<Solid electrolytic capacitors E1 to E4 and C1 to C3>>

Solid electrolytic capacitors including a plurality of laminated capacitor elements as shown in FIG. 2 were produced and evaluated in the manner described below.

### (1) Preparation of Anode Body

An anode body was produced by etching and roughening both surfaces of an aluminum foil (thickness: 100 μm) as a base material.

### (2) Formation of Dielectric Layer

At least the second part of the anode body was immersed in a chemical conversion liquid and a 2.5-V DC voltage was applied for 20 minutes to form a dielectric layer containing aluminum oxide.

### (3) Formation of Solid Electrolyte Layer

A separation part was formed by adhering an insulating resist tape to the end portion of the first part on the second part side of the anode body on which the dielectric layer was formed. The anode body on which the separation part was formed was immersed in a liquid composition containing a conductive material, taken out, and dried to form a precoat layer (not shown).

An aqueous solution containing a pyrrole monomer and an aromatic sulfonic acid compound as a dopant was prepared. In this aqueous solution, the monomer concentration was 0.5 mol/L, and the concentration of the dopant was 0.3 mol/L. In polymerization 1 shown in Table 1, 5-sulphosalicylic acid was used, and in polymerization 2,5-sulfoisophthalic acid was used.

The anode body on which the precoat layer was formed and a counter electrode were immersed in the obtained aqueous solution, and subjected to electrolytic polymerization at 25° C. under a polymerization voltage of 3V (polymerization potential relative to a silver reference electrode) to form a solid electrolyte layer. Then, a drying process was performed at 80° C. for 5 minutes.

### (4)Formation of Cathode Part

The anode body obtained in step (3) was immersed in a dispersion liquid obtained by dispersing graphite particles in water, was taken out from the dispersion liquid, and was dried to form a first layer (carbon layer) on at least the surface of the solid electrolyte layer. Drying was performed at 215° C. for 10 to 20 minutes.

Next, a silver paste containing silver particles and an epoxy resin was applied to the surface of the first layer, and the epoxy resin was cured by performing a heating process at 210° C. for 10 minutes to form a second layer containing silver particles. In this manner, a cathode extraction layer constituted of the first layer and the second layer was formed. As described above, a plurality of capacitor elements were formed.

### (5) Lead Connection

A copper sheet (100 μm thick) for forming an anode lead and a cathode lead was processed to form frame-like leads (lead frames). The front and back main surfaces of the part to be an embedded part of each lead frame (corresponding to the front and back main surfaces of the copper sheet) were roughened through sandblasting. The surfaces corresponding to the exposed part were not roughened. In roughening the surfaces of the embedded part, blast beads with different average particle sizes were used so that the interface developed area ratio Sdr measured using the procedure described above had the value shown in Table 1. The average particle size of the blast beads used in E1 to E4 and C1 was ⅕ of the average particle size of the blast beads used in C2 and C3. As for the surfaces corresponding to the exposed part (the surfaces that were not roughened), the interface developed area ratio Sdr measured using the procedure described above was 0.2.

Of the plurality of capacitor elements obtained in step (4), six capacitor elements were laminated so that their first parts overlapped each other and their second parts overlapped each other, thereby forming a laminated body of capacitor elements. The first end portions of the first parts of the anode bodies were bundled, and one end portion of the anode lead was joined to the bundled part through laser welding. The cathode extraction layers of adjacent capacitor elements were bonded via an adhesive layer of a conductive adhesive. The cathode extraction layer of the capacitor element arranged at the end portion in the laminating direction of the capacitor elements and one end portion of the cathode lead were bonded with an adhesive layer of a conductive adhesive. A total of 20 such laminated bodies of capacitor elements were fabricated.

### (6) Drying Process

In E1 to E3 and C3, the laminated bodies of capacitor elements obtained in step (5) were dried under the drying conditions (temperature and time) shown in Table 1. On the other hand, in E4, C1, and C2, such a drying process was not performed.

### (7) Assembly of Solid Electrolytic Capacitor

In E1 to E3 and C3, the laminated bodies dried in step (6) were used to assemble solid electrolytic capacitors, and in E4 and C1 to C2, the laminated bodies obtained in step (5) were used to assemble solid electrolytic capacitors. Specifically, an exterior body made of an insulating resin was formed by molding around each laminated body of capacitor elements. At this time, the other end portions of the anode leads and the other end portions of the cathode leads were drawn out from the exterior bodies. In this manner, the solid electrolytic capacitors were completed. In the same manner as above, a total of 20 solid electrolytic capacitors were produced. Table 1 shows the rated voltages, rated capacities, and heights of the obtained solid electrolytic capacitors. The height of each solid electrolytic capacitor is the length of the solid electrolytic capacitor (not including the leads) in a direction parallel to the laminating direction of the capacitor elements.

### [Evaluations]

The solid electrolytic capacitors were evaluated for the following:

### (a) Amount of Gas Generated

The amount of gas (μL) generated in a solid electrolytic capacitor when subjected to the processing corresponding to reflow was measured by the procedure described above.

### (b) Airtightness Defect Rate

The solid electrolytic capacitors were subjected to reflow processing in conformity with IPC/JDEC J-STD-020D. Specifically, each solid electrolytic capacitor was heated for 30 seconds at a temperature of 255° C. or higher (maximum temperature 260° C.). After that, the solid electrolytic capacitor was evaluated for airtightness with a gross leak test. Specifically, the solid electrolytic capacitor was placed inside a small capsule of the apparatus described below, and a minute pressure drop (a pressure change due to S.DET (small leak)) generated due to the internal pressure of the small capsule leaking into the exterior body was measured. Then, the capacitors whose pressure change was larger than a predetermined value (0.02 [kPa]) were determined as having airtightness defects, and the defect rates (%) were calculated.
Apparatus: Leak tester MSX-0101 manufactured by Fukuda Co., Ltd.
Conditions: Test pressure (400 [kPa]) and measurement time (2.0 [sec])

### <<Solid Electrolytic Capacitors C4 to C6>>

Twenty each of three types (C4 to C6) of commercially available solid capacitors were prepared, and their gas amounts and airtightness defect rates were determined in the same manner as E1. Table 1 shows the rated voltages and rated capacities of the solid electrolytic capacitors, the numbers of capacitor elements constituting the laminated bodies, and the heights of the solid electrolytic capacitors.

Table 1 shows the evaluation results. In Table 1, E1 to E4 indicate examples, and C1 to C6 indicate comparative examples.

TABLE 1

| | Rated | Rated | | | | | Lead | Amount of | Airtightness |
|---|---|---|---|---|---|---|---|---|---|
| | voltage | capacity | Number of | Height | | | frame | gas generated | defect rate |
| | (WV) | (μF) | elements | (mm) | Polymerization | Drying conditions | Sdr | (μL/product) | (%) |
| E1 | 2 | 470 | 6 | 1.9 | Polymerization 1 | 200° C. 40 hours | 0.6 | 1039 | 0 |
| E2 | | | | | | 200° C. 30 hours | 0.6 | 1255 | 0 |
| E3 | | | | | | 200° C. 20 hours | 0.6 | 1505 | 0 |
| E4 | | | | | Polymerization 2 | — | 0.6 | 995 | 0 |
| C1 | 2 | 470 | 6 | 1.9 | Polymerization 1 | — | 0.6 | 4318 | 40 |
| C2 | | | | | | — | 0.3 | 4532 | 25 |
| C3 | | | | | | 200° C. 20 hours | 0.3 | 1759 | 15 |

| | | | | | | | |
|---|---|---|---|---|---|---|---|
| C4 | 2 | 470 | 8 | 2.8 | — | 2382 | 45 |
| C5 | 2.5 | 330 | 4 | 1.9 | — | 4373 | 85 |
| C6 | 2.5 | 470 | 6 | 2.8 | — | 5109 | 75 |

As shown in Table 1, if a lot of gas is generated in the solid electrolytic capacitor when subjected to the processing corresponding to mounting reflow, the airtightness defect rate becomes high (C1 and C2). In solid electrolytic capacitors that generate a large amount of gas, if the Sdr of the lead frame is large, the airtightness defect rate becomes particularly high (comparison between C1 and C2). This is possibly because the large Sdr of the lead frame can suppress air intrusion from the outside, but if gas is generated inside the solid electrolytic capacitor, the internal pressure will become too large and the airtightness will deteriorate. It is conceivable that the amount of gas generated increased in C1 and C2 because the dopant used in polymerization 1 contained a hydroxy group, which facilitated the generation of condensed water in the capacitor elements.

Even when using a dopant that generates a large amount of gas, sufficiently drying the capacitor elements reduces the amount of gas generated when subjected to the processing corresponding to mounting reflow. Therefore, even if the Sdr of the lead frame is large, it is possible to suppress the increase in internal pressure and ensure high airtightness (E1 to E3). However, even if the capacitor elements are sufficiently dried, if the Sdr of the lead frame is small, the effect of suppressing the intrusion of air or moisture from the outside will deteriorate. Therefore, although the amount of gas generated when subjected to the processing corresponding to mounting reflow is reduced to some extent, it is difficult to sufficiently suppress deterioration of the airtightness (C3).

Furthermore, when the dopant in polymerization 2 is used, condensed water is less prone to be generated. Thus, even if the capacitor elements are not subjected to a drying process, the amount of gas generated when subjected to the processing corresponding to mounting reflow is low (E4). In addition, the large Sdr of the lead frame suppresses the intrusion of air or moisture from the outside, and therefore it is possible to ensure high airtightness (E4).

On the other hand, as compared to E1 to E4, the commercially available solid electrolytic capacitors C4 to C6 generated a large amount of gas when subjected to the processing corresponding to mounting reflow, and had high airtightness defect rates.

Although the present invention has been described using embodiments that are preferred at the present time, such disclosure is not intended to be construed as limiting. Various changes and modifications will no doubt become apparent to those skilled in the art to which the present invention pertains upon reading the above disclosure. It is, therefore, intended that the appended claims be construed as covering all changes and modifications without departing from the true spirit and scope of the present invention.

### INDUSTRIAL APPLICABILITY

The solid electrolytic capacitor of the present disclosure can ensure high airtightness even when exposed to high temperatures. Therefore, it is possible to suppress deterioration in capacitor performance such as an increase in ESR or a decrease in capacitance, and ensure high reliability. Therefore, the solid electrolytic capacitor is suitable for various use applications such as those that require reliability and those for which use in high-temperature environments is expected. However, these use applications are mere examples, and use applications of the solid electrolytic capacitor are not limited to these examples.

### REFERENCE SIGNS LIST

1, 21: solid electrolytic capacitor, 2, 22: capacitor element, 3: exterior body, 4: anode lead, 5: cathode lead, 4a, 5a: embedded part, 4b, 5b: exposed part, 6: anode body, 7: dielectric layer, 8: cathode part, 9: solid electrolyte layer, 10: cathode extraction layer, 11: first layer, 12: second layer, 13: separation part, 14: adhesive layer, L: laminated body of a plurality of capacitor elements, e1: first end portion of anode body 6, e2: second end portion of anode body 6, D_{T}: thickness (or laminating direction) of capacitor element, D_{L}: length direction of capacitor element

1. A solid electrolytic capacitor comprising:
a capacitor element; and
an exterior body that seals the capacitor element,
wherein the capacitor element includes an anode body, a dielectric layer that is formed on a surface of the anode body, a cathode part that covers at least a portion of the dielectric layer, an anode lead with one end portion electrically connected to the anode body, and a cathode lead with one end portion electrically connected to the cathode part,
another end portion of the anode lead and another end portion of the cathode lead are drawn out from the exterior body,
the cathode part includes a solid electrolyte layer that covers at least a portion of the dielectric layer, and
a total amount of gas generated in the following (e) and the following (f) is 1600 μL or less,
when the solid electrolytic capacitor is subjected to:
(a) heating at 155° C. for 24 hours;
(b) cooling to 30° C. at 60% RH or less;
(c) leaving to stand for 168 hours at 30° C. and 60% RH;
(d) cutting at a center in a length direction at 25° C. and under an inert atmosphere;
(e) heating the cut solid electrolytic capacitor to 150° C. at a rate of 50° C./min under an inert atmosphere, heating from 150° C. to 200° C. at a rate of 16.7° C./min, heating from 200° C. to 260° C. at a rate of 40° C./min, continuously heating at 260° C. for 10 seconds, and cooling from 260° C. to 30° C. at a rate of 16.7° C./min; and
(f) repeating the (e) two more times.

2. The solid electrolytic capacitor according to claim 1,
wherein the solid electrolyte layer contains a conjugated polymer and a dopant, and
the dopant includes a benzenesulfonic acid compound.

3. The solid electrolytic capacitor according to claim 1,
wherein the solid electrolyte layer contains a conjugated polymer and a dopant, and
the dopant includes a compound that has an aromatic ring, at least one sulfo group bonded to the aromatic ring, and at least two functional groups selected from the group consisting of a carboxy group bonded to the aromatic ring and a hydroxy group bonded to the aromatic ring.

4. The solid electrolytic capacitor according to claim 1,
wherein the solid electrolyte layer contains a conjugated polymer and a dopant, and
the dopant includes a compound that has an aromatic ring, at least one sulfo group bonded to the aromatic ring, and at least two carboxy groups bonded to the aromatic ring, and does not have a hydroxy group.

5. The solid electrolytic capacitor according to claim 3, wherein the aromatic ring is a benzene ring.

6. The solid electrolytic capacitor according to claim 1,
wherein each of the anode lead and the cathode lead is divided into an embedded part that includes the one end portion and is embedded in the exterior body and an exposed part that includes the other end portion and is exposed from the exterior body,
at least one of the anode lead and the cathode lead has a rough surface with an interface developed area ratio Sdr of 0.4 or more, and
the rough surface is present on at least a portion of the embedded part.

7. The solid electrolytic capacitor according to claim 6,
wherein each of the anode lead and the cathode lead has the rough surface, and
each of the rough surface is present on at least a portion of the embedded part.

8. The solid electrolytic capacitor according to claim 7,
wherein the embedded part of the anode lead has a contact surface p that is in contact with the exterior body,
the embedded part of the cathode lead has a contact surface n that is in contact with the exterior body,
a percentage of the area of the rough surface in the area of the contact surface p is 50% or more, and
a percentage of the area of the rough surface in the area of the contact surface n is 50% or more.

9. The solid electrolytic capacitor according to claim 6, wherein the rough surface is present on at least a portion of the embedded part and is present on at least a portion of the exposed part.
